(19) United States
(12) Patent Application Publication
(10) Pub. No.: US 2008/0029119 A1
(43) Pub. Date: Feb. 7, 2008

(54) Novel Cleansing Composition

(76) Inventor: Barbara Jean Fealy, Fridley, MN (US)

Correspondence Address: THE ESTEE LAUDER COS, INC, 155 PINELAWN ROAD, STE 345 S, MELVILLE, NY, 11747, US

(21) Appl. No.: 11/570,664

(22) PCT Filed: Jul. 1, 2005
(86) PCT No.: PCT/US05/23533

§ 371 Date: May 9, 2007

Related U.S. Application Data
(60) Provisional application No. 60/584,565, filed on Jul. 1, 2004.

(51) Int. Cl. C11D 3/36; C11D 9/36

(52) U.S. Cl. 132/202; 510/466; 510/468

(57) ABSTRACT

A cleansing composition comprising at least one surfactant, at least one nonvolatile silicone oil and at least one hydrogenated phospholipid suspending agent, and methods of use thereof.

### FIELD OF THE INVENTION

The present invention relates to cleansing compositions and methods. In particular, the present invention relates to a novel cleansing and conditioner composition.

### BACKGROUND OF THE INVENTION

Hair care compositions that impart both shampoo and conditioning properties to the hair simultaneously are well known in the art. Such compositions are desirable because of the elimination of a separate composition for cleaning and conditioning the hair. However, there are processing and formulation complications that are inherent in two-in-one-shampoos. Specifically, two-in-one shampoos typically contain at least one surfactant for cleaning the hair and a conditioning agent such as a high molecular weight conditioning oil. The conditioning oils often rinse out with the composition and are not transferred to the desired location. In order to retain the high molecular weight oils within the composition, suspending agents such as acrylates copolymers and carbomers are used to form a matrix with the oils and thereby hold the oils within the composition.

In an age when consumers are often seeking products that contain natural ingredients, there is a continual need for finding substitutes for commonly used synthetic cosmetic ingredients. As such, there is a need for a replacement for suspending agents such as acrylates copolymers or carbomers with natural substitutes in two-in-one compositions that provide both the desired cleansing and moisturizing effects.

### SUMMARY OF THE INVENTION

The present invention comprises a cleansing composition comprising at least one surfactant, at least one nonvolatile silicone oil and at least one hydrogenated phospholipid suspending agent.

The present invention further comprises a method of cleansing and conditioning the hair comprising applying to the hair a composition comprising at least one surfactant, at least one nonvolatile silicone and at least one hydrogenated phospholipid suspending agent.

### DETAILED DESCRIPTION

Except in operating and comparative examples, or where otherwise explicitly indicated, all numbers in this description indicating amounts or ratios of material or conditions of reaction, physical properties of materials and/or use are to be understood as modified by the word “about.” All amounts are by weight of the final composition, unless otherwise specified. The term “naturally-derived refers to non-animal derived, non-petrochemically derived ingredients.

The present invention teaches a cleansing composition comprising a novel combination of at least one nonvolatile silicone oil as a conditioning agent, at least one hydrogenated phospholipid as a suspending agent for the conditioning agent, and at least one surfactant.

Conditioning agents are commonly used in two-in-one shampoos to condition the hair. Suitable materials are those that deliver benefits such as shine, softness, combability, wet-handling, anti-static properties, damage protection, volume, stylability and manageability. The present invention teaches the use of nonvolatile silicones as suitable conditioning agents. Suitable nonvolatile silicones include polyalkyl siloxanes, polyalkylaryl siloxanes, polyether siloxane polymers and silicone gums.

The non-volatile polyalkyl siloxanes that may be used in the cleansing composition include polydimethyl siloxanes with viscosities ranging from about 5 to 600,000 centistokes at 25° C. These siloxanes are available, for example, from the General Electric Company as the Viscasil series and from Dow Coming as the Dow Corning 200 series. The viscosity can be measured by means of a glass capillary viscometer as set forth in Dow Coming 200 series. The viscosity can be measured by means of a glass capillary viscometer as set forth in Dow Coming Corporate Test Method CTM0004, Jul. 20, 1970. Preferably, the viscosity ranges from about 350 centistokes to about 100,000 centistokes.

The non-volatile polyalkylaryl siloxanes that may be used in the cleansing composition include polymethylphenylsiloxanes having viscosities of about 15 to 65 centistokes at 25° C. These siloxanes are available, for example, from the General Electric Company as SF 1075 methyl phenyl fluid or from Dow Coming as 556 Cosmetic Grade Fluid. Additionally, poly(dimethyl siloxane) (diphenyl siloxane) copolymers having a viscosity in the range of from about 10 to about 100,000 centistokes at 25° C. may be used.

Non-volatile polyether siloxane copolymers that may be used include a polypropylene oxide modified dimethylpolysiloxane (Dow Corning, DC-1248). Ethylene oxide or mixtures of ethylene oxide and propylene oxide may also be used in the cleansing compositions. References disclosing suitable nonvolatile dispersed silicone compounds include U.S. Pat. No. 2,826,551; U.S. Pat. No. 3,964,500; U.S. Pat. No. 4,364,837; and British Pat. No. 849,433 provide an extensive, though not exclusive, listing of suitable silicone compounds.

Suitable silicone gums refer to polydiorganosiloxanes having a molecular weight of from 200,000 to 1,000,000, as well as gums with a slight degree of cross-linking, as are described, for example, in WO 96/31188. Specific examples of polydiorganosiloxanes include dimethicone gums, dimethiconol gums, polydimethyl siloxane/diphenyl/methylvinylsiloxane copolymers, polydimethylsiloxane/methylvinylsiloxane copolymers and mixtures thereof. References disclosing suitable silicone gums include U.S. Pat. No. 4,152,416, and from General Electric Silicone Rubber product Data Sheet SE 30, SE 33, SE 54 and SE 76.

The nonvolatile silicone is added to the cleansing composition in an amount sufficient to provide improved combing and improved softness to the hair. The preferred non-volatile silicone is a non-volatile dimethicone having a viscosity for example, of 100,000 centistokes at 25° C.

The nature of the conditioning agent has led to difficulties in creating a stable two-in-one cleansing formulation. Therefore, suspending agents that stably hold the conditioning oil within the formulation are utilized. The present invention has surprisingly found that hydrogenated phospholipids act as suspending agents for conditioning agents.

In a preferred embodiment, it has surprisingly been found that naturally-derived ingredients may be beneficially used as suspending agents. It is important to note that not all naturally derived ingredients are suitable as suspending agents in the present composition, as shown in Example 2 below (xanthan gum ineffective as suspending agent).

Phospholipids are fat derivatives in which one fatty acid has been replaced by a phosphate group and one of several nitrogen-containing molecules. Examples of phospholipids include lecithin, phosphatidyl ethanolamine, phosphatidic acid, phosphatidylinositol, phosphatidylserine, phosphatidyl chlorine, phosphatidyl glycerol, sphingomyelin, and cardiolipin. Phospholipids are commercially available from Vitacorp International in Houston, Tex.

Hydrogenation involves saturation of the phospholipids with hydrogen. It has been surprisingly found that hydrogenated phospholipids suspend the conditioning agent while non-hydrogenated phospholipids do not seem to support the conditioning agent within the cleansing composition, as shown in Example 2 below. While not wishing to be bound by any theories, it is believed that because hydrogenation breaks the double bonds in phospholipids to create single bonds, thereby rendering the phospholipid stronger, the hydrogentated phospholipid can surprisingly suspend the high molecular weight nonvolatile silicones within the cleansing composition. Hydrogenated phospholipids are commercially available from, for example, Avanti Polar Lipids, Inc. in Alabaster, Ala.

In a preferred embodiment, hydrogenated lecithin is used as the suspending agent. Hydrogenated lecithin may be naturally derived from sources such as soybeans, corn, cottonseed and rapeseed. The hydrogenated lecithin is used in an amount of from 0.1 to 10%, preferably from 0.5 to 3% and most preferably from 0.75 to 1.5% by weight of the composition. While not wishing to be bound by any theories, it is believed that the particle size of the hydrogenated lecithin aids in its ability to suspend the conditioning agent as opposed to acting as an emulsifier, thereby stably holding the conditioning agent in a matrix.

As an added benefit, hydrogenated phospholipids are reported to be an important constituent of the natural moisturizing factor of the skin (including hair) and are a significant contributor to providing an attractive skin appearance.

To provide the cleansing aspect of the present cleansing composition, at least one surfactant is included as an ingredient. The surfactant should preferably providing foaming properties since the heavy conditioning agent often suppresses any foaming qualities in a cleansing composition. Suitable surfactants include anionic, amphoteric and zitterionic surfactants commonly used in cleansing compositions.

Examples of anionic surfactants include, but are not limited to alkyl sulphates, alkyl ether sulphates, alkaryl sulphonates, alkanoyl isethionates, alkyl succinates, alkyl sulphosuccinates, N-alkoyl sarcosinates, alkyl phosphates, alkyl ether phosphates, alkyl ether carboxylates, alpha-olefin sulphonates and acyl methyl taurates, especially their sodium, magnesium ammonium and mono-, di- and triethanolamine salts. The alkyl and acyl groups generally contain from 8 to 18 carbon atoms and may be unsaturated. The alkyl ether sulphates, alkyl ether phosphates and alkyl ether carboxylates may contain from one to 10 ethylene oxide or propylene oxide units per molecule, and preferably contain 2 to 3 ethylene oxide units per molecule.

Examples of suitable anionic surfactants include but are not limited to sodium oleyl succinate, sodium methyl cocoyl taurate, disodium coco-glucoside citrate, ammonium lauryl sulphate, ammonium lauryl sulphosuccinate, sodium cocoyl isethionate, sodium lauroyl isethionate, sodium N-lauryl sarcosinat, sodium dodecylbenzene sulphonate, triethanolamine dodecylbenzene sulphonate, sodium cocosulfate, babassa sulfate and sodium N-lauryl sarcosinate. The amount of anionic surfactant in the cleansing composition of the present invention range from 3 to 60%, preferably from 5 to 55%, and most preferably from 7 to 50%.

Examples of amphoteric and zwitterionic surfactants include, but are not limited to alkyl amine oxides, alkyl betaines, alkyl amidopropyl betaines, alkyl sulphobetaines, alkyl glycinates, alkyl carboxyglycinates, alkyl amphopropionates, alkylamphoglycinates and alkyl amidopropyl hydroxysultaines, acyl taurates and acyl glutamates, wherein the alkyl and acyl groups have from 8 to 19 carbon atoms. More specifically, examples include but are not limited to lauryl amine oxide, cocodimethyl sulphopropyl betaine, lauryl betaine, babassuamidopropyl betaine, cocamidopropyl betaine and sodium cocamphopropionate.

The amount of amphoteric or zwitterionic surfactant in the cleansing composition of the present invention range from 3 to 50%, preferably from 3 to 30%, and most preferably from 5 to 20%. The amphoteric or zwitterionic surfactants may be used in combination with each other or with other co-surfactants. The optional co-surfactants are typically selected from nonionic surfactants, amphoteric surfactants, cationic surfactants and mixtures thereof.

Further surfactants may also be present as emulsifiers for emulsified components of the cleansing composition. Suitable emulsifying surfactants are well-known in the art and include anionic and nonionic surfactants. These may be the same as those listed hereinabove or may be different. For example, suitable anionic surfactants used as emulsifiers include alkylarylsuphonates, alkyl sulphates, alkyl ether sulphates, ether sulfates, and sulphosuccinates. Examples of nonionic surfactants used as emulsifiers include alkylphenol ethoxylates, alcohol ethoxylates, and ester ethoxylates.

Cleansing compositions frequently include opacifiers to enhance consumer appeal. Opacifiers create an opaque look for the composition and may provide added moisturizing and stabilizing benefits. Examples of opacifying agents include higher fatty alcohols (e.g., cetyl, stearyl, arachidyl and behenyl), solid esters (e.g., cetyl palmitate, glyceryl laurate, stearamide MEA-stearate), high molecular fatty amides and alkanolamides and various fatty acid derivatives such as propylene glycol and polyethylene glycol esters. Inorganic materials used to opacify hair treatment compositions include magnesium aluminum silicate, zinc oxide, and titanium dioxide.

In the preferred embodiment, a combination of stearic acid and potassium stearate is used as an opacifier. The opacifiers are generally used in a total amount of from 0.01 to 20%, preferably from 0.01 to 5% and most preferably from 0.2 to 2.5%.

The compositions of the present invention are especially suitable as shampoo compositions, and more specifically two-in-one cleansing compositions. The two-in-one cleansing compositions are preferably oil-based compositions, but may also be formulated as a water-based composition. It is contemplated that the cleansing compositions may also be in the form of a cream composition. The preferred process according to the present invention for making the present composition can be, for example, through a simple mixing process. The conditioning agent and suspending agent are preferably premixed to a solution. The surfactant is mixed with water with the addition of heat. Optional ingredients are added as needed to the surfactant composition prior to heating. The two solutions are then mixed in a tank to form a uniform composition.

The present invention may further include optional ingredients, for example, preservatives, pearlescing agents, antidandruff agents, pH adjusting agents, foam stabilizers, conditioning agents, natural hair root nutrients (e.g. amino acids and sugars), hair fibre benefit agents (e.g., ceramides), perfumes and colorants. Further examples can be found in the International Cosmetic Ingredient Dictionary and Handbook, CTFA, Tenth Edition, 2004. Any additional components required to formulate such products vary with product type and can be routinely chosen by one skilled in the art.

Particularly preferred embodiments of the present formulations are two-in-one cleansing compositions. The cleansing composition may also take other suitable forms appropriate to the suspended conditioning agent which they contain and are intended to deposit. For example, suitable uses include body shampoos, shower gels, facial washing compositions, bath foams and the like.

The compositions may be applied to the skin or hair, as appropriate, and worked to create a lather. The lather may be retained at the applied site for a short time, e.g., one or several minutes, before rinsing, or may be immediately rinsed. The procedure may be repeated as desired.

The following examples further illustrate the invention, but the invention is not limited thereto.

### EXAMPLE 1

The inventive composition used in the examples is provided herein below. Optional ingredients are also disclosed in this composition, but is not intended to be limiting.

| INGREDIENT | INCI Name | PERCENT |
|---|---|---|
| USP Purified Water | Water | 38.322000 |
| SZD Flaxseeds | Linium Usitatissimum | 0.001000 |
| SZD Alfalfa Leaf Powder | Medicago Sativa | 0.001000 |
| UCARE JR-30 M | Polyquaternium-10 | 0.6000 |
| Methocel J5MS | Hydroxypropyl Methycellulose | 0.60000 |
| Tauranol WS Conc | Sodium Methyl Cocoyl Taurate | 29.0000 |
| Mackam BB-30 | Babassuamidopropyl Betaine | 11.0000 |
| Incronam BA-30 | Babassuamidopropyl Betaine | 1.0000 |
| Eucarol AGE-EC | Disodium Coco-Glucoside Citrate | 7.0000 |
| Lamesoft PO-65 | Coco-Glucoside (and) Glyceryl Oleate | 5.0000 |
| Methylparaben NF | Methylparaben | 0.20000 |
| Propylparaben NF | Propylparaben | 0.20000 |
| Versene 220 | Tetrasodium EDTA | 0.20000 |
| Stearic Acid Triple-Press Veg | Stearic Acid | 1.10000 |
| Potassium Stearate OPK-1000 | Potassium Stearate | 1.10000 |
| FG K | | |
| Silicone HL88 | Dimethicone | 0.75000 |
| Sea Buckthorn Oil | Hippophae Rhamnoides Oil/Olea Europa | 0.01000 |
| Lecinol S-10 | Hydrogenated Lecithin | 1.25000 |
| Dow Corning 1664 Emulsion | Water (and) Dimethicone (and) Laureth-4 | 2.00000 |
| Cert Org-derived Quinoa Protein | Chenopodium Quinoa | 0.10000 |
| Bois II | Santalum Album (Sandalwood) Extract | 0.05000 |
| Annatto WS-Formil Brazil | Annatto | 0.001000 |
| Kathon CG | Methylchloroisothiazolinone (and) | 0.095000 |
| | Methylisothiazol | |
| UL-0038 | Fragrance | 0.30000 |
| Citric Acid Fine Granular | Citric Acid | 0.12000 |

### EXAMPLE 2

The inventive composition is tested with 1.25% hydrogenated lecithin (Lecinol S-10) versus 1.25% non-hydrogenated lecithin (Emulmetik 100) to evaluate the stability of the final product. Samples of each composition are stored in a jar and stored in different temperature conditions for year. Observations are made on the stability of each sample after 2 weeks, 1 month, 2 months, 3 months and 1 year. The shelf life of a shampoo composition for two to three years is predicted based on stability at elevated temperatures at three months. The samples of the two compositions are evaluated for one year and the observations are provided in Tables 1 and 2 below.

TABLE 1
STABILITY OF COMPOSTION COMPRISING
NON-HYDROGENATED LECITHIN

| | Room | | | |
|---|---|---|---|---|
| Time | Temperature | 35° C. | 45° C. | 50° C. |
| 2 weeks | STABLE | STABLE | STABLE | oil droplets, |
| | | | | ⅓ top of jar |
| 1 month | STABLE | 20% | ½ inch oil | 3 layers of |
| | | separation | on surface | separation |
| 2 months | falling apart | Too | Too | Too unstable- |
| | | unstable- | unstable- | discarded |
| | | discarded | discarded | |
| 3 months | falling apart | Too | Too | Too unstable- |
| | | unstable- | unstable- | discarded |
| | | discarded | discarded | |
| 1 year | 4-5 layers | Too | Too | Too unstable- |
| | of | unstable- | unstable- | discarded |
| | separation | discarded | discarded | |

TABLE 2
STABILITY OF COMPOSITION COMPRISING HYDROGENATED
LECITHIN

| | Room | | | |
|---|---|---|---|---|
| Time | Temperature | 35° C. | 45° C. | 50° C. |
| 2 weeks | STABLE | STABLE | STABLE | STABLE |
| 1 month | STABLE | STABLE | STABLE | STABLE |
| 2 months | STABLE | STABLE | STABLE | clear liquid |
| | | | | 20% of |
| | | | | bottom of jar |
| 3 months | STABLE | 10% clear | 15% clear | 25% clear |
| | | liquid on | liquid on | liquid on |
| | | bottom of jar | bottom of jar | bottom of jar |
| 1 year | Slight clear | Too | Too | Too unstable- |
| | layer on | unstable- | unstable- | discarded |
| | bottom, 1/16 | discarded | discarded | |
| | inch in 2.5 | | | |
| | inch jar | | | |

As seen from the results in Tables 1 and 2 above, the stability of the composition comprising non-hydrogenated lecithin begins to separate at 2 weeks at 50 C. Within two months, the composition comprising non-hydrogenated lecithin becomes unstable at room temperature. In contrast, the present inventive composition comprising hydrogenated lecithin is stable for 3 months at room temperature with only a slight sign of clear liquid on the bottom of the jar at elevated temperatures.

### EXAMPLE 3

The inventive composition comprising hydrogenated lecithin is compared to the composition with the substitution of xantham in place of the hydrogenated lecithin. The stability of the composition is observed over a week. The observations are provided in Table 3 below.

TABLE 3
STABILITY OF COMPOSITION COMPRISING HYDROGENATED LECITHIN v.
XANTHAN

| | Room | | | | | |
|---|---|---|---|---|---|---|
| | Temperature | | 45° C. | | 50° C. | |
| | 3 days | 1 week | 3 days | 1 week | 3 days | 1 week |
| Hydrogenated Lecithin (Lesenol S- | Stable | Stable | Stable | Stable | Stable | Stable |
| 10) (1.25%) | | | | | | |
| Xanthan (1%) | Stable | Stable | Stable | Unstable, | Unstable, | Unstable, |
| | | | | Separates | Separates | Separates |

As seen from the results above, substitution of a naturally-derived ingredient such as xanthan gum for hydrogenated lecithin in the present inventive composition does not yield a stable product, thereby rendering the results from hydrogenated lecithin unexpected. Specifically, xanthan gum is believed to be incapable of acting as a suspending agent since the composition comprising xanthan gum separates at 45° C. after 1 week and is unstable after 3 days when stored at a temperature of 50° C.

It should be understood that the specific forms of the invention herein illustrated and described are intended to be representative only. Changes, including but not limited to those suggested in this specification, may be made in the illustrated embodiments without departing from the clear teachings of the disclosure. Accordingly, reference should be made to the following appended claims in determining the full scope of the invention.

What is claimed is:

1. A cleansing composition comprising:
at least one surfactant;
at least one nonvolatile silicone; and
at least one hydrogenated phospholipid suspending agent.

2. The cleansing composition of claim 1 wherein the naturally-derived hydrogenated phospholipid suspending agent is naturally-derived and is hydrogenated lecithin.

3. The cleansing composition of claim 1 wherein the nonvolatile silicone is selected from the group consisting of polyalkyl siloxanes, polyalkylaryl siloxanes, polyether siloxane polymers and silicone gums.

4. The cleansing composition of claim 1 wherein the surfactant is selected from the group consisting of anionic and amphoteric surfactants.

5. The cleansing composition of claim 1 further comprising an opacifier system comprising stearic acid and potassium stearate.

6. A cleansing composition comprising:
at least one surfactant;
at least one nonvolatile silicone;
at least one hydrogenated phospholipid suspending agent; and
an opacifier system.

7. The cleansing composition of claim 6 wherein the hydrogenated phospholipid suspending agent is naturally-derived and is lecithin.

8. The cleansing composition of claim 6 wherein the nonvolatile silicone is selected from the group consisting of polyalkyl siloxanes, polyalkylaryl siloxanes, polyether siloxane polymers and silicone gums.

9. The cleansing composition of claim 6 wherein the surfactant is selected from the group consisting of anionic and amphoteric surfactants.

10. The cleansing composition of claim 6 wherein the opacifier system comprises a mixture of stearic acid and potassium stearate.

11. A method of cleansing and conditioning the hair comprising applying to the hair a composition comprising:
at least one surfactant;
at least one nonvolatile silicone; and
at least one hydrogenated phospholipid suspending agent.

12. The method of claim 11 wherein the hydrogenated phospholipid suspending agent is naturally-derived and is lecithin.

13. The method of claim 11 wherein the nonvolatile silicone is selected from the group consisting of polyalkyl siloxanes, polyalkylaryl siloxanes, polyether siloxane polymers and silicone gums.

14. The method of claim 11 wherein the surfactant is selected from the group consisting of anionic and amphoteric surfactants.

15. The method of claim 11 wherein the composition further comprises an opacifier system comprising a mixture of stearic acid and potassium stearate.
